(19) United States
(12) Patent Application Publication
(10) Pub. No.: US 2015/0277572 A1
(43) Pub. Date: Oct. 1, 2015

(54) SMART CONTEXTUAL DISPLAY FOR A WEARABLE DEVICE

(71) Applicant: BASIS SCIENCE, INC., San Francisco, CA (US)

(72) Inventors: Christopher Verplaetse, San Francisco, CA (US); Steven Patrick Szabados, San Francisco, CA (US); Marco Kenneth Della Torre, San Francisco (AU)

(73) Assignee: Intel Corporation, Santa Clara, CA (US)

(21) Appl. No.: 14/438,207

(22) PCT Filed: Oct. 24, 2013
(86) PCT No.: PCT/US2013/066716

§ 371 Date: Apr. 23, 2015

Related U.S. Application Data
(60) Provisional application No. 61/717,642, filed on Oct. 24, 2012.
(60) Provisional application No. 61/727,074, filed on Nov. 15, 2012.

(51) Int. Cl. G06F 3/01; G09G 5/18; G09G 5/10

(52) U.S. Cl. CPC G06F 3/017; G06F 3/011; G09G 5/10; G09G 5/18

(57) ABSTRACT

A system and a method are disclosed for a display on a device based on context for the device. Motion data along two axes associated with the device is received and the motion data indicates a context for the device such as a position of a body part on which the device is worn. Additionally time points associated with the motion data are received. The display is modified if the motion data along two axes has values within predetermined ranges.

### CROSS REFERENCE TO RELATED APPLICATIONS

This application claims the benefit of U.S. Provisional Patent Applications No. 60/717,642 filed Oct. 24, 2012 and 61/727,074 filed Nov. 15, 2012 under 35 USC §119(e), the contents of both of which are herein incorporated by reference.

### BACKGROUND

1. Field of Art

The disclosure generally relates to the field of modifying and controlling a display for a wearable device based on a context of the device.

2. Description of the Related Art

Wearable devices such as watches, music players and the like enable users to interact with technology in a convenient and continuous manner, since they can be present on the body in the context of all lifestyle activities. Devices now have more and more functions. While additional functionality is supposed to add utility, increased functionality also means interacting with the device more to activate the various functions. Additionally, wearable devices are preferably small and thus any controls are also small. These aspects result in devices that have less than desired utility.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 illustrates one embodiment of a wearable device with a display.

FIG. 2 illustrates another view of an embodiment of a wearable device.

FIG. 3 illustrates a flow chart for activating a display according to one embodiment.

FIG. 4 illustrates a wearable device and axes around which motion is determined according to one embodiment.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

One embodiment of the disclosed device and method includes a motion detection system to identify the context of a device. The context of the device is a function of its motion and relative position as well as time. The context of the device can be a position of the device relative to the user or an activity in which the user is engaged. In one embodiment, the operation of a screen (or display) of the device is modified in response to the identified context. Modifying operation of the display includes, but is not limited to, activating or deactivating the display, increasing or decreasing a brightness of the display, turning on a backlight on the display, and providing information on the display. In one embodiment, the identified context is the device facing the user and in response to that context, a screen (or display) of the device is activated. Activating the display includes turning on the display or turning on a backlight to make the display more visible. In other embodiments, the context for the device results in specified content being provided on the display of the device.

### Example Device Configuration

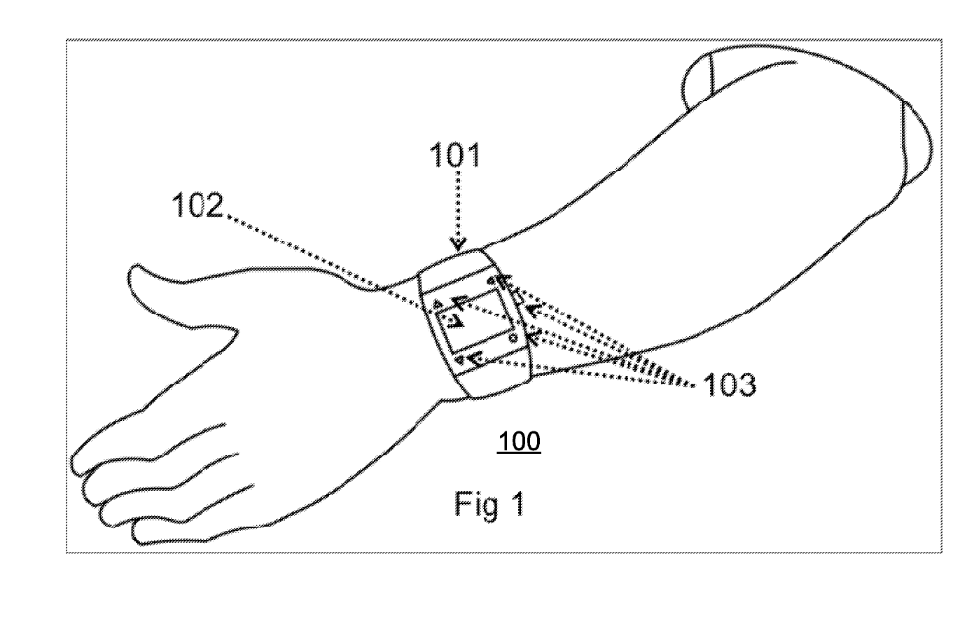

Referring now to FIG. 1, it illustrates an embodiment of a wearable device 100. The exemplary device 100 is worn on the wrist attached through a fastening system 101. The fastening system 101 may be removable, exchangeable or customizable. The device 100 includes a display 102 and user interaction points 103.

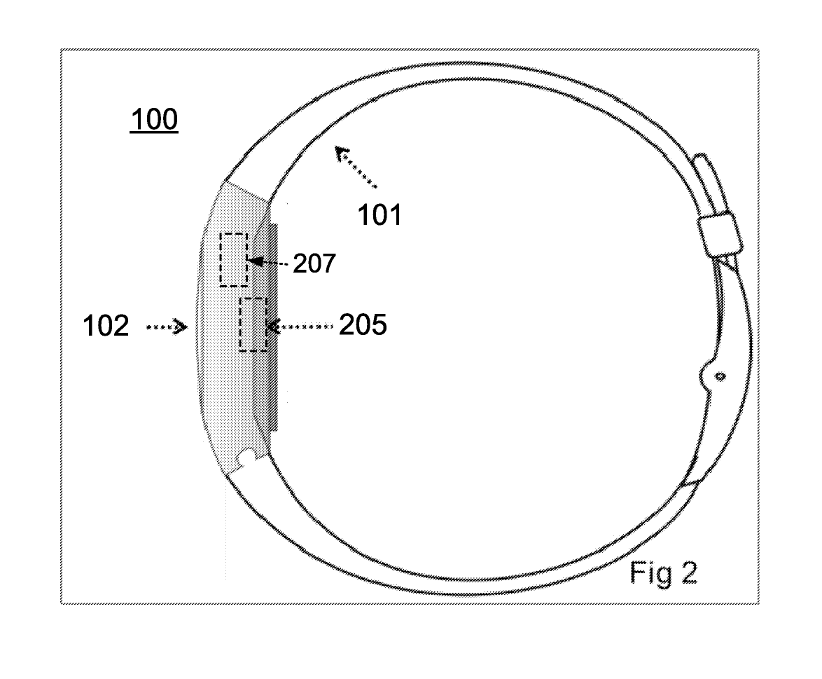

FIG. 2 illustrates another view of an embodiment of the wearable device 100. The view includes the fastening system 101, display 102. Additionally the motion system 207 and processor 205 are shown. Example processors 205 include the TIMSP430 from TEXAS INSTRUMENTS and ARM Cortex-M class microcontrollers. The processor 205 receives data from the position system 207 and determines when to activate display 102. The motion system 207 is any kind of motion sensor. Example motion sensors include an accelerometer, a gyroscope, a pressure sensor, a compass and a magnetometer.

### Example Processing Configuration

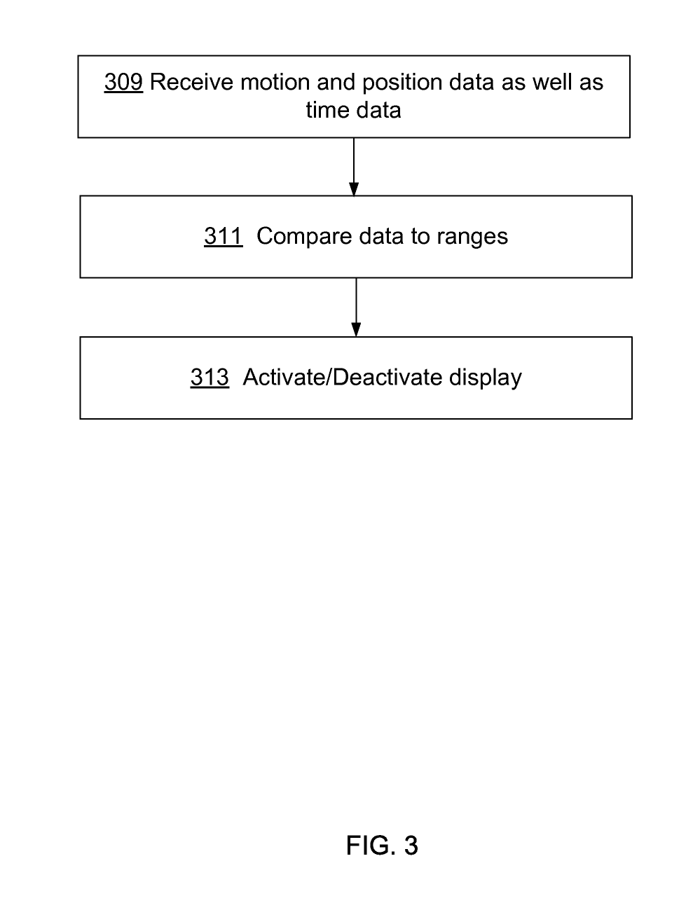

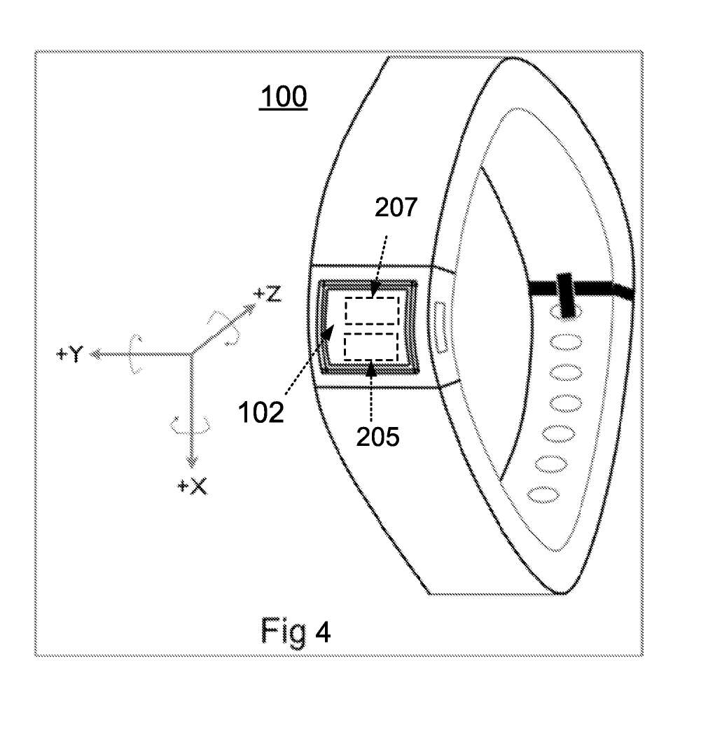

An example of the disclosed device and method is described in reference to FIGS. 3 and 4. In this example, the context identified is the device 100 being positioned to face the user and in response the display 102 is activated or deactivated. Referring to FIG. 3, as the device 100 is worn, the processor 205 receives 309 data from the motion system 207 in three axes. The motion system 207 in this embodiment is an accelerometer. FIG. 4 illustrates another view of an embodiment of the device 100 and shows one example of the axes relative to which motion data and position data is determined by the motion system 207. The processor 205 compares 311 the data for each axis and determines when each axis is within a predetermined range. The predetermined ranges are indicative that the device has been turned to face the user. Responsive to the data indicating that the device has been turned to face the user, the processor activates 313 the display 102. The processor 205 determines the device has been turned to face the user based on data from one or more axes being within its predetermined range for a threshold period of time. In one embodiment, predetermined ranges for motion data are within an X-Y-Z Cartesian coordinate system for a user wearing a device 100 while in an upright position, for example:

X axis: +0.8 g to 1 g
Y axis: −0.2 g to 0.2 g
Z axis: −0.2 g to 0.2 g
In some embodiments, the processor activates the display when the data along one or more axes falls within its predetermined threshold for more than 300 milliseconds (ms). In other embodiments, the data along the one or more axes for 250 or 500 ms. For various uses of the disclosed system, the optimal time period can be determined such that the display does not activate inadvertently and still turns on quickly enough to be responsive to the user's expectation.

The processor 205 continues to monitor motion and relative position data and deactivates the display 102 when the motion and relative position data fall outside the range that triggered activation. In some embodiments, the processor 205 deactivates the display after data from the motion system 207 for just one of the axes is no longer in the threshold range. The processor 205 can deactivate the display 102 instantaneously or after the data for the one axis remains outside the threshold for 500 ms.

In another embodiment, processor 205 continuously monitors the motion system 207 and activates the display 102 when there is a rotational motion of the device 100 with a principal rotational axis coincident with that of the user's wrist. If the user is upright, the wrist is along the Y-axis (referring to FIG. 4) and rotation in the negative Y direction yielding an increasing X acceleration due to increased coincidence with gravity indicates display 102 is being rotated toward user. For example, a change in the positive X acceleration of +0.25 g over the course of a predetermined time period, e.g., 1 second, may indicate such a rotation. When the condition is met within a certain predefined timeframe, and when rotation stops with the device oriented with the display 102 (defined by the X/Y plane as in the example above) the processor 205 activates display 102. The processor 205 applies timing windows and orientation range limits to protect against the activation of the backlight during similar gesticulations such as running or showering.

In another embodiment, the processor 205 activates the display 102 when there is complex rotational motion of the device 100 with multiple axes of rotation. The first rotational component corresponding to rotation of the user's forearm about their elbow (primarily observed as a rotation about the Z axis), thus indicating that the user's forearm is being swung or lifted up toward the user's face. A second rotational component corresponding to rotation of the user's wrist (see the rotation about the “Y-axis”, as in the example above, and in FIG. 4), in the negative Y direction, thus indicating display 102 is being rotated toward the user. For example, in order to capture a user bringing the device 100 from their side, into viewing position, the following operations may be detected:
1. An initial position determined by the gravity vector being coincident with the negative Y axis.
2. As the hand is brought up from the user's side, a rotation in the negative Z axis is detected as the gravity vector is observed to move from the negative Y direction to the negative X direction.
3. As the user rotates the forearm to view the display 102, a complex rotation is observed with a negative rotation in the Y axis
4. The device 100 is then observed to remain in the final orientation observed at the end of the previous step for a period of time, indicating that the user is viewing the device 100 and the display 102 should be activated. This period of time could be 300 ms, as in the above example. Similarly, the device could disable the display 102 with a change in orientation, a rotation out of this position or a timeout. This timeout could also be 500 ms, as in the example above.

In yet another embodiment, the processor 205 applies an algorithm to the orientation of the gravity vector, relative to the device's reference frame. The output of the algorithm identifies complex rotations that indicate a change in user context. For example, (referring to FIG. 4) when device 100 rotation causes the gravity vector to traverse the X/Y plane and indicate rotation in the negative Y direction, with rotation stopping at a device orientation indicating user viewing, and when these conditions are met within a certain predefined timeframe, the processor 205 will activate the display 102. In this embodiment, a window of rotational components may also be defined, whereby the timeframe to execute the rotations is 1 second. The algorithm uses timing windows and orientation range limits to protect against the activation of the display 102 during similar gesticulations such as running or showering.

In some embodiments the display 102 cannot be activated for a predetermined amount of time after it has been deactivated. Optionally, reactivation is blocked only after a threshold number of activations and deactivations within a given time period. This further protects against inadvertent activation of the display 102. For example, if the display has been activated and deactivated a number of times in a minute, it is likely that the activation is in error and thus it is beneficial to prevent the display 102 from reactivating for a period of time such as 5 seconds or 10 seconds.

### Additional Exemplary Process Configurations

In addition to activating the display in response to the device 100 be positioned to face the user, the processor 205 can provide specified content for display on display 102 based on an identified context of the device 100. The identification of context includes learning from the user's interactions with the device 100. For example, if a user accesses data from the device 100 around the same time every morning, the processor 205 can display the usual data in response to the device 100 facing the user at that time. If the device 100 is turned to face the user at another time of day, the processor 205 merely activates the display 102 but does not provide any particular content.

Aside from activating a backlight, the device 100 may use context information to modify other display parameters based on context, including the contrast, brightness, orientation or displayed content. The device may also use other feedback such as an audio cue or a physical feedback such as vibration.

A context may also be used to trigger input. For example, rather than (or in addition to) activating a backlight the device 100 may activate other functions such as a microphone to enable voice recording, a speaker to activate sound, a telephony or voice-activated feature, or the connection to a wireless network to synchronize its data or new display content. Example wireless networks include a LAN, MAN, WAN, mobile network, and a telecommunication network.

In yet another embodiment, the device 100 communicates via the wireless network to modify operation of a display on a remote device in the same way that operation of a display on the device 100 is modified. Operation of the remote display may be modified in addition to or in place of modifying operation of the display 104 on the device 100.

A combination of contexts may be detected in sequence to create additional contextual information. For example, if the motion system 207 detects that a user is stepping (e.g., walking, running), and the device 100 is facing the user, a recent step count may be displayed as well as the backlight being activated. This is an example of two detected contexts providing additional opportunity for customization of the user experience based on more than one detected context in parallel or in sequence. Another example would be using a detection of sleep to disable a backlight being activated. For example, if the motion system 207 detects a period of low motion, the device 100 may require a period of high motion before the automatic backlight would again be activated when the device is positioned to face the user. This would be advantageous because it is possible for the device 100 to be turned to face the user during sleep. If the display 102 were activated, this could wake the user.

An additional identified context collected may also represent social gestures such as a handshake, “fist bump”, or “high five”. Since this action has a particular orientation and acceleration pattern associated with it, the context of this social gesture may be detected and used to modify the nature of the data displayed or stored around the event. For example, a precise timestamp, location, data signature or other information may be saved as a result of this event. The information could also be compared to other users' saved data as a means of identifying social gestures between users. For example, if another user from a similar location had engaged in a similar gesture at the same time, these two users could be linked on a network, share some information or have the event recorded on the device 100 for subsequent processing.

Another example of multiple contexts being used to generate behavior or user information would be the automatic detection of which hand the device 100 is being worn on. By using the accelerometer signals to detect step events, as well as orientation, the device 100 can infer where on the body or in which orientation the device 100 is being worn. For example, if the device 100 is being worn on the wrist, a first context of slowly stepping and a second context of the orientation of the device 100 could be used to determine which wrist the device 100 is being worn on.

The device 100 may incorporate other sensors and use them to improve the mechanism described above. These may be to provide additional contextual information, or to provide information for display based on contextual conditions. Examples of each of these sensors are summarized in Table 1 below.

| Sensor Category | Sensor Examples |
|---|---|
| Motion | Accelerometer, Gyroscope, Pressure Sensor, |
| | Compass, Magnetometer |
| Non-invasive, in- | Techniques such as optical, ultrasound, laser, |
| ternal physiological | conductance, capacitance |
| parameter sensing | |
| Thermal | Skin Temperature, ambient Temperature, core |
| | temperature |
| Skin Surface | Galvanic skin response, electrodermal activity, |
| Sensors | perspiration, sweat constituent analysis (cortisol, |
| | alcohol, adrenalin, glucose, urea, ammonia, lactate) |
| Environmental | Ultraviolet light, visible light, moisture/humidity, |
| | air content (pollen, dust, allergens), air quality |

### Motion

Motion sensing can provide additional contextual information via the detection and recognition of signature motion environments, actions, and/or contexts such as: in-car, in-airplane, walking, running, swimming, exercising, brushing teeth, washing car, eating, drinking, shaking hands, arm wrestling. The example outlined in the algorithms above, whereby an accelerometer is used to detect the gesture corresponding to the wearer looking at the device 100 is another example. Other gestures such as a fist-bump, hand shake, wave, or signature are further examples. Motion and relative position analytics may also be calculated for display, such as step count, activity type, context specific analysis of recent activity, summaries for the day, week, month or other time period to date.

In some embodiments, multiple motion sensors can be used. For example both an accelerometer and gyroscope could be used. Additional types of motion sensors provides for more detailed inputs allowing for determination of additional contexts of the device 100.

In some embodiments, a detected context is an activity in which a user is engaged. An example activity is exercise. Exercises that involve repeated motion are detected by the processor 205 by identifying from motion data received from the motion system 207 repeated motions within a predetermined time period. Lifting weights and jumping jacks are examples of exercises that involve repeating the same motion.

### Non-Invasive, Internal Physiological Parameter Sensing

The device 100 may contain non-invasive, internal physiological parameter sensing such as the detection of blood flow, respiration or other parameters. These could be used to detect context, or as inputs to the display triggered by a context detected. For example, an accelerometer could detect the context of running, followed by the context of looking at the device 100, and the device 100 could display both a detected distance for the run and the maximum heart rate. Similarly, the device 100 could detect the blood alcohol level of the wearer and, if above a threshold, this context could trigger a visual alert to the user.

### Thermal

Thermal sensors could be used to detect body, skin and ambient temperature for the purpose of context detection or display parameters. For example, a sensor able to detect skin temperature could use this information to infer the context of the user exerting himself physically and change the display to reflect parameters relevant to physical effort. Thermal information may also be relevant to display based on other contexts. For example, if the wearer is sweating due to physical exertion, the difference between environmental temperature and skin temperature could provide a parameter to inform the time to recovery from the physical exertion. In this case the context could be detected by an accelerometer, but the displayed metric be derived (at least in part) from thermal sensors.

In another embodiment a chance in temperature identifies the context that the wearer of the device has changed locations. Depending on the weather, there is a temperature difference between inside and outside of buildings, vehicles etc. For example, a drop in ambient temperature from 90 degrees F. to 75 degrees F. indicates the user has left outside and gone into a building.

### Skin Surface Sensors

Skin surface sensors detect parameters purely via measuring non-invasively from the skin surface. For example, a galvanic skin response or electrodermal activity sensor may be used to detect small changes in skin surface conductivity and thereby detect events such as emotional arousal. This can be used as context for an adaptive display modification, such as triggering the backlight or vibrating the device 100 to alert the user to the stress event and help them take action to mitigate it. For example, a device 100 could vibrate more strongly if a stress event was more pronounced. A perspiration sensor could also be used to generate a display of workout parameters such as intensity if the context of physical exertion was detected. This context could be detected by the perspiration sensor itself, or by another sensor such as the accelerometer.

### Environmental Sensors

Sensors that detect signals pertaining to the environment around the wearer provide both a unique reference point for signals sourced from the wearer himself, as well as additional context to inform adaptive processing and display. For example, a device 100 that included an ultraviolet light sensor could modify the display when the user had received the recommended maximum exposure to ultraviolet light for the day. A user whose context has been determined to be sweating via a skin surface perspiration sensor may be exposed to a display of the humidity in the air around them as a result of this contextual awareness.

Environmental sensors can also be used to identify a change from an indoor to outdoor context (or vice versa). An ambient light sensor would sense the change from generally lower light indoors to generally brighter light outdoors. Depending on whether, a humidity sensor an also identify this context. Heating and cooling a building often results in less humidity than outdoors. Thus an increase or decrease in humidity is indicative of changing context from indoors to outdoors or the reverse.

### Additional Considerations

The disclosed embodiments beneficially allow for making a device more intuitive and therefore useful for the user. The more a device provides desired information without being specifically requested to do so, the more useful it is. For example, activating a display only when it is needed and without explicit instruction to do so by the user also provides additional security for the user as the display may be displaying health-related information such as stress levels. Additionally power is saved by only activating the display in it is needed.

Some portions of above description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for modifying operation of a device in response to an identified context through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

1-30. (canceled)

31. A method for controlling a display on a device, the method comprising:
receiving motion data along two axes associated with the device, the data associated with a plurality of time points;
determining a context of the device based on the motion data and the plurality of time points; and
modifying operation of the display in response to the determined context.

32. The method of claim 31 further comprising receiving motion data along a third axis associated with the device and associated with a plurality of time points and wherein determining a context of the device is based on the motion data along each of the three axes and associated pluralities of time points.

33. The method of claim 31 wherein the context comprises at least one of a position of a body part on which the device is worn and a motion of the body part on which the device is worn.

34. The method of claim 31 wherein modifying operation of the display comprises activating the display and further comprising:
receiving a second set of motion data corresponding to each of the two axes associated with the device;
determining a second context for the device based on the second set of motion data; and
deactivating the display in response to one axis of the second set of motion data having a value outside a second predetermined range of values.

35. The method of claim 31 wherein modifying the display comprises at least one of turning on a backlight, modifying a brightness of the display, and providing information for display.

36. The method of claim 31 wherein the context comprises an activity of the user wearing the device.

37. The method of claim 36 wherein modifying the display comprises providing information relevant to the activity.

38. A system for controlling a display on a device, the system comprising a processor configured to:
receive motion data along two axes associated with the device, the data associated with a plurality of time points;
determine a context of the device based on the motion data and the plurality of time points; and
modify operation of the display in response to the determined context.

39. The system of claim 38 wherein the processor is further configured to receive motion data along a third axis associated with the device and associated with a plurality of time points and wherein determining a context of the device is based on the motion data along each of the three axes and associated pluralities of time points.

40. The system of claim 38 wherein the context comprises at least one of a position of a body part on which the device is worn and a motion of the body part on which the device is worn.

41. The system of claim 38 wherein modifying operation of the display comprises activating the display and the processor if further configured to:
receive a second set of motion data corresponding to each of the two axes associated with the device;
determine a second context for the device based on the second set of motion data; and
deactivate the display in response to one axis of the second set of motion data having a value outside a second predetermined range of values.

42. The system of claim 38 wherein modifying the display comprises at least one of turning on a backlight, modifying a brightness of the display, and providing information for display.

43. The system of claim 38 wherein the context comprises an activity of the user wearing the device.

44. The system of claim 43 wherein modifying the display comprises providing information relevant to the activity.

45. A computer readable medium configured to store instructions, the instructions when executed by a processor cause the processor to:
receive motion data along two axes associated with the device, the data associated with a plurality of time points;
determine a context of the device based on the motion data and the plurality of time points; and
modify operation of the display in response to the determined context.

46. The computer readable medium of claim 45 further comprising instructions that cause the processor to receive motion data along a third axis associated with the device and associated with a plurality of time points and wherein determining a context of the device is based on the motion data along each of the three axes and associated pluralities of time points.

47. The computer readable medium of claim 45 wherein the context comprises a position of a body part on which the device is worn, a motion of the body part on which the device is worn, and an activity of the user wearing the device.

48. The computer readable medium of claim 45 wherein modifying operation of the display comprises activating the display and further comprising instructions that cause the processor to:
receive a second set of motion data corresponding to each of the two axes associated with the device;
determine a second context for the device based on the second set of motion data; and
deactivate the display in response to one axis of the second set of motion data having a value outside a second predetermined range of values.

49. The computer readable medium of claim 45 wherein modifying the display comprises at least one of turning on a backlight, modifying a brightness of the display, and providing information for display.

50. The computer readable medium of claim 47 wherein modifying the display comprises providing information relevant to the activity.
